(19) United States
(12) Patent Application Publication
(10) Pub. No.: US 2018/0033231 A1
(43) Pub. Date: Feb. 1, 2018

(54) COIN OPERATED DOOR LOCK MECHANISM

(71) Applicant: FSP Holdings Pty Ltd, Singleton, New South Wales (AU)

(72) Inventor: Stephan Hewitt, Yatala, Queensland (AU)

(21) Appl. No.: 15/554,996

(22) PCT Filed: Mar. 3, 2016
(86) PCT No.: PCT/AU2016/050141

§ 371 Date: Aug. 31, 2017

(30) Foreign Application Priority Data
Mar. 3, 2015 (AU) 2015900734

(51) Int. Cl. G07F 5/02; E05B 17/20; G07F 17/12; E05B 65/02

(52) U.S. Cl. CPC G07F 5/02; E05B 65/025; E05B 17/2007; G07F 17/12

(57) ABSTRACT

A coin operated lock assembly (30) is provided for attachment to a locker (12), the locker including a cabinet (14) and a door (16). The cabinet defines a locker loop (18) for locking the door using a padlock or the like. The coin operated lock assembly (30) includes a coin operated key lock mechanism including a locking plate (50) which is moved by operation of the key lock, wherein insertion of a coin in the lock allows the door to be locked and the key removed from the lock and wherein the locker is locked by means of a bolt (42) which is fixed to, or movable by, the locking plate (50) and which passes through the locker loop (18) of the locker when the assembly is attached to the locker door.

### CROSS-REFERENCE TO RELATED APPLICATIONS

The present application claims priority from Australian Provisional Patent Application No 2015900734 filed on 3 Mar. 2015, the content of which is incorporated herein by reference.

### BACKGROUND

Lockers are commonly used for the temporary safe storage of a person's possessions, such as valuables, school books, clothes and the like. They are common in many environments, particularly in schools, in gyms, and in workplaces where people change from everyday clothes into work uniforms and vice versa. As the name suggests, most lockers include a means for locking the locker, sometimes with an integral key operated lock, sometimes with locks that are card or PIN operated and some simply have a metal loop (“locker loop”) for receiving an external padlock. School lockers are commonly locked using external padlocks as the loss of a key is less significant, and also the use of external padlocks is a cheaper solution.

In some facilities where lockers are provided for temporary use, particularly in public facilities such as swimming pools there is usually a charge for use of a locker. One common way of charging for lockers is by the use of a coin which must be inserted for the locker key to be removed but which is retained when the key is re-inserted to open the locker.

Such mechanisms can be quite complex, and can add significantly to the cost of the locker.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

According to the present invention there is provided a coin operated lock assembly for attachment to a locker, the locker including a cabinet and a door, the cabinet defining a locker loop for locking the door using a padlock or the like, wherein the coin operated lock assembly includes a coin operated key lock mechanism including a locking plate which is moved by operation of the key lock, wherein insertion of a coin in the lock allows the door to be locked and the key removed from the lock and wherein the locker is locked by means of a bolt which is fixed to, or movable by, the locking plate and which passes through the locker loop of the locker when the assembly is attached to the locker door.

Advantageously, the coin operated lock assembly may be attached to existing lockers which are provided with a locker loop for use in locking the locker using padlocks or the like, and may use that locker loop when locking the locker. This allows the cost effective conversion of existing non-coin operated lockers to coin operated lockers, and avoids the need to make significant adjustments to the existing locker to allow for coin operated locking. In this case all that is required in the machining of a hole on the locker door to accommodate components of the assembly. Regardless, it allows the same basic locker design to be used for both types of locker with minimal adjustments.

Thus in a related aspect there is provided a locker comprising a cabinet and a door, the cabinet defining a locker loop for locking the door using a padlock or the like, the door including a coin operated key lock mechanism including a locking plate which is moved by operation of the key lock, wherein insertion of a coin in the lock allows the door to be locked and the key removed from the lock and wherein the locker is locked by means of a bolt which is fixed to or movable by the locking plate and which through the locker loop.

The assembly may include a housing defining a slot and pathway for coin inserted into the assembly, and a latch arranged to inhibit movement of the locking plate until the latch has been displaced by a coin inserted into the assembly.

Stop means may be provided for limiting the movement of the latch until the locking plate has been moved to lock the locker.

Preferably, the assembly further includes a tab mounted on the locking plate and arranged to cooperate with the latch to temporarily retain the coin, until the lock is unlocked.

### BRIEF DESCRIPTION OF DRAWINGS

A specific embodiment of the invention will now be described, by way of example only, and with reference to the accompanying drawings in which:

FIG. 1 shows a bank of lockers which can be locked using padlocks and locker loops;

FIG. 2 shows a front view of a locker incorporating a coin operated lock assembly;

FIG. 3 shows a side view of the locker of FIG. 2;

FIG. 4 shows a section on A-A of FIG. 3;

FIG. 5 is an enlarged detailed view of area B of FIG. 4;

FIG. 6 is a perspective view of a lock assembly;

FIG. 7 is an inverted rear view of the lock assembly of FIG. 6;

FIG. 8 is a top plan view of the lock assembly of FIG. 6

FIG. 9 is a schematic view illustrating a first stage in the operation of the lock assembly;

FIG. 10 is a schematic view illustrating a second stage in the operation of the lock assembly;

FIG. 11 is a schematic view illustrating a third stage in the operation of the lock assembly; and

FIG. 12 is a schematic view illustrating a fourth stage in the operation of the lock assembly.

### DESCRIPTION OF EMBODIMENTS

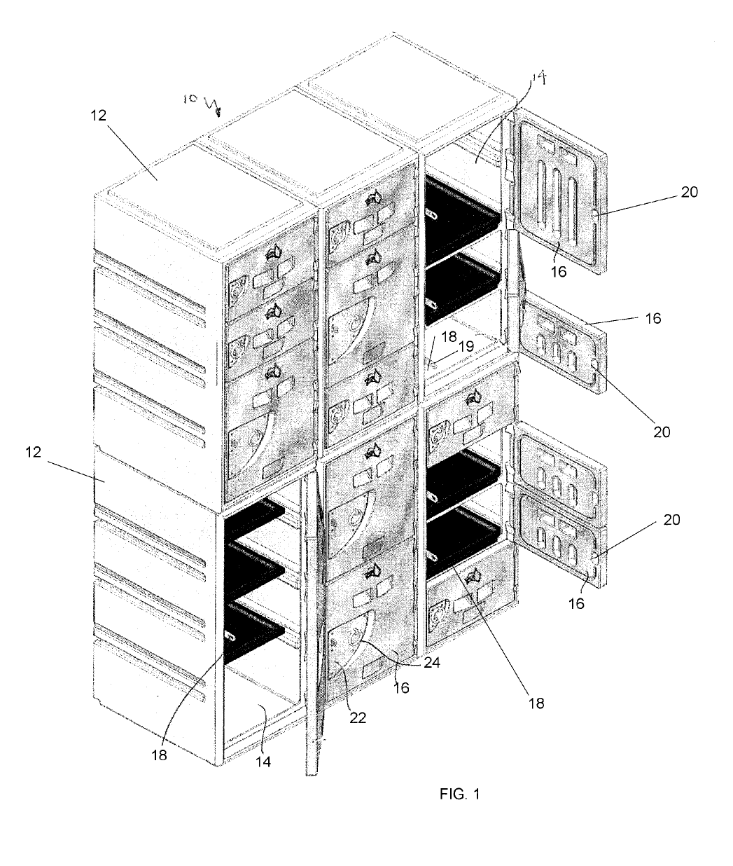

Referring to the drawings, FIG. 1 shows a bank 10 of lockers 12. Each of the lockers defines an internal compartment/volume 14 which may be closed by a door 16 which is hinged to the wall of the locker. A metal locker loop 18 projects from one side of the front of the compartment on the opposite side to the hinge. The locker loop 18 comprises a metal plate in which a hole 19 is defined. Each door defines a slot 20 through which the locker loop 18 passes when the door is closed. This allows the locker to be locked using a padlock or the like the shackle of which passes through the hole 19 in the locker loop. It can also be seen that the door defines a recess 22 in its front, in which the slot 20 and a handle 24 is located, the recess being in the shape of a quadrant of a circle having two straight perpendicular sides and one curved side.

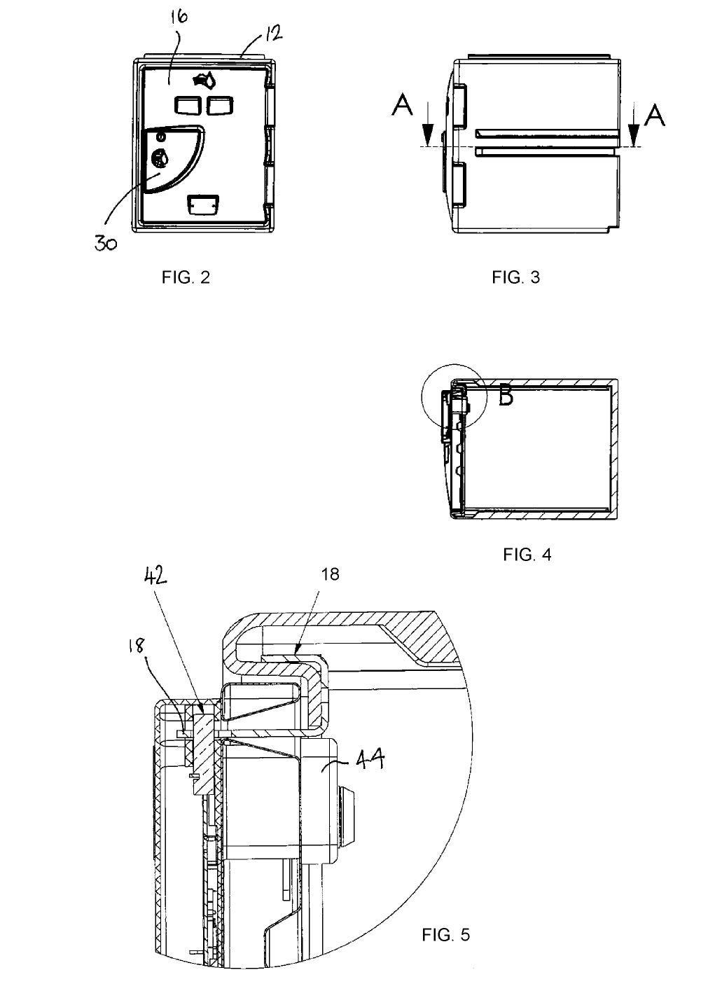

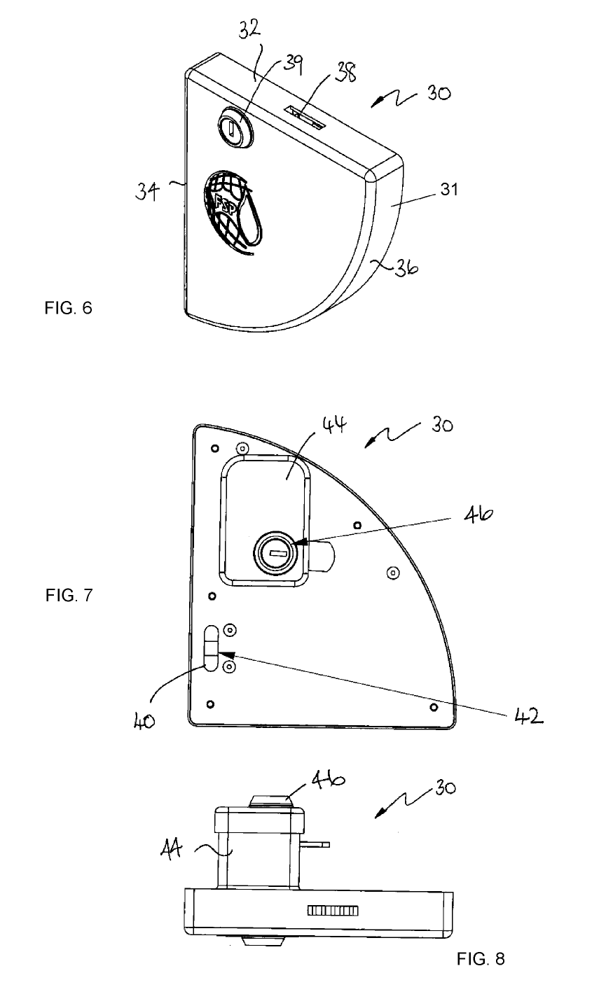

FIGS. 6 to 8 show a coin-operated lock assembly 30 which may be located in the recess 22 in a locker door 16. FIG. 2 shows the assembly 30 fixed to the locker door 16. The assembly includes an outer case or housing 31 which is in the shape of a quadrant of a circle having two straight perpendicular sides 32, 34 and one curved side 36. It includes a slot 38 for receiving a coin and a front latch/lock 39 defining a slot for receiving a key. As is best seen in FIG. 7, the lock assembly defines a slot 40 which in use fits over an existing locker loop of a locker, such as is shown in FIG. 1. Part of a bolt 42 which passes into the slot can also be seen in FIG. 7. The door also defines a compartment 44 for holding retained coins. The compartment may be opened to remove the retained coins using a keyed lock 46, which is different to the key for opening the locker itself.

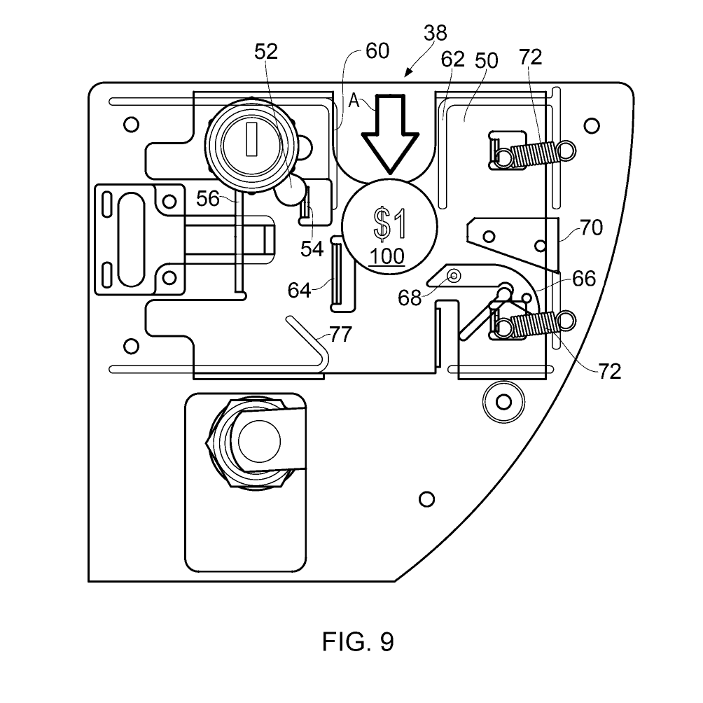

FIGS. 9 to 12 illustrate the features and operation of the lock mechanism in more detail. The mechanism includes a generally planar locking plate 50, but which is folded in places to define a number of tabs oriented at 90° to the plane of the plate, which can be moved to the right and to the left by means of a tongue 52 which rotates as the lock/latch 39 is turned and the tongue contacts opposed tabs/stops 54, 56 thus pushing the plate to the left or right.

Also shown in FIGS. 9 to 12, opposed side walls 60, 62 which are part of the moulded housing 31 define a chute or vertical pathway into which a coin may drop when inserted into the slot 38. Below one side wall 60 there is a tab 64 which is integral with the plate 50. On the opposite side of the chute there is a curved latch 66 mounted to the plate 50 by a pivot pin 68. Above the latch there is a stop means in the form of a stopper plate 70 which limits the pivoting movement of the latch. Springs 72 are attached to the plate to bias the plate to the right. The latch defines a curved recess 74 which receives a integrally moulded stop 76 which is a part of the housing and prevents the plate from moving. The housing also defines a integrally moulded v-shaped coin stop/guide 77.

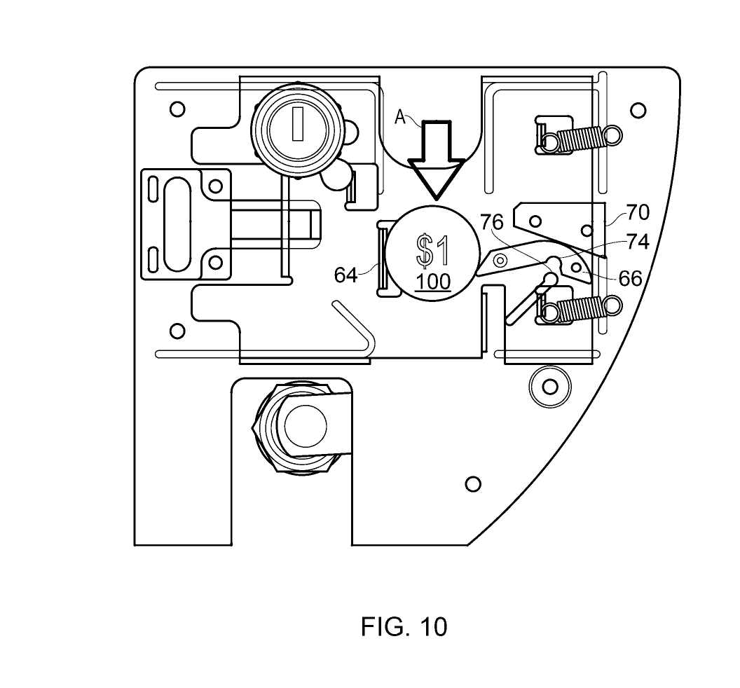

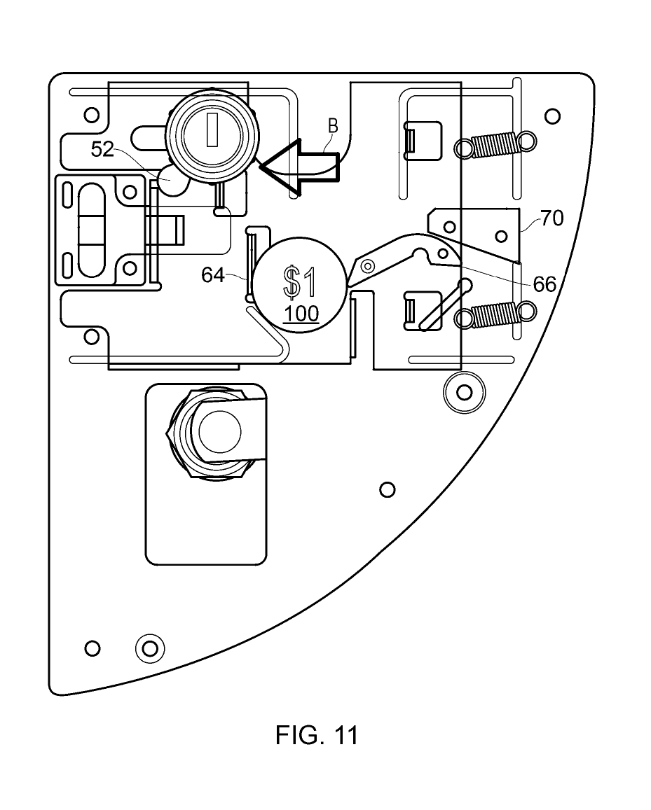

In use, as shown in FIGS. 9 and 10, a coin 100 is fed in through the slot 38. The coin drops into the lock assembly in the direction of arrow A, until it becomes wedged between the tab 64 and the pivoting latch 66. As shown in FIG. 10, the weight of the coin causes the latch 66 to pivot sufficiently to release the stop 76 from engagement in the recess 74 and allows the lock mechanism to be locked, by allowing the plate to be moved to the left in the direction of the arrow B, shown in FIG. 11.

FIG. 11 shows that when the key is turned in the lock the tongue 52 rotates in a clockwise direction and impacts on the tab/stop 56 and causes the plate to move to the left in the direction of the arrow B. The bolt 42 which is attached to the plate moves with the plate and slides through the locker loop 18 (also shown in FIG. 5) thus locking the door and preventing the door opening. The movement of the plate to the left allows the latch to pivot further as shown in FIG. 11, and the coin drops further in the mechanism but is prevented from dropping by the v-shaped coin stop/guide 77.

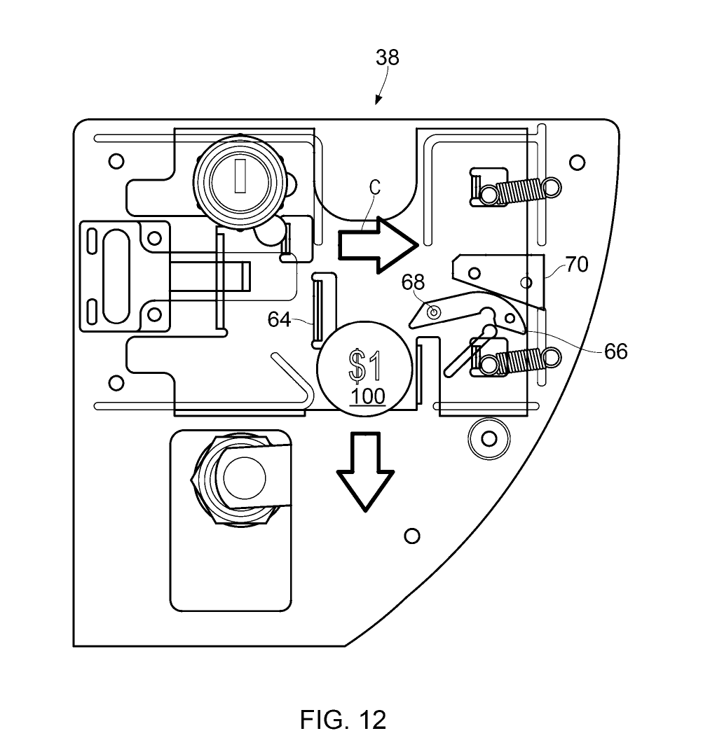

To unlock the door the operator turns the key to move the tongue in an anti-clockwise direction which moves the tongue 52 to the right in the direction of the arrow C, as shown in FIG. 12. The tab 64 pushes the coin to the right and as the plate 50 and coin move the coin clears the v-shaped coin stop/guide 77 and drops into the coin store 44 which is located below the latching mechanism.

The stopper plate 70 guides the latch back to its start position.

The mechanism as described suits an Australian one dollar coin but it will be appreciated that the position of the stop 64 could be adjusted to allow the mechanism to be used with coins of different sizes for use in other jurisdictions.

Although the locker loop as shown in the drawings and as described above is a metal plate defining a hole for receiving a padlock, it will be appreciated that other designs of locker loop are possible such as a ring, or U-shaped element, for example.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A coin operated lock assembly for attachment to a locker, the locker including a cabinet and a door, the cabinet defining a locker loop for locking the door using a padlock or the like, wherein the coin operated lock assembly includes a coin operated key lock mechanism including a locking plate which is moved by operation of the key lock, wherein insertion of a coin in the lock allows the door to be locked and the key removed from the lock and wherein the locker is locked by means of a bolt which is fixed to, or movable by, the locking plate and which passes through the locker loop of the locker when the assembly is attached to the locker door.

2. A coin operated lock assembly as claimed in claim 1 including a housing defining a slot and pathway for coin inserted into the assembly, and a latch arranged to inhibit movement of the locking plate until the latch has been displaced by a coin inserted into the assembly.

3. A coin operated lock assembly as claimed in claim 2 further including a stop means for limiting the movement of the latch until the locking plate has been moved to lock the locker.

4. A coin operated lock assembly as claimed in claim 3 further including a tab mounted on the locking plate and arranged to cooperate with the latch to temporarily retain the coin, until the lock is unlocked.

5. A coin operated lock assembly as claimed in claim 1 wherein the locker loop comprises a metal plate defining an aperture capable of receiving a shackle of a padlock.

6. A locker comprising a cabinet and a door, the cabinet defining a locker loop for locking the door using a padlock or the like, the door including a coin operated key lock mechanism including a locking plate which is moved by operation of the key lock, wherein insertion of a coin in the lock allows the door to be locked and the key removed from the lock and wherein the locker is locked by means of a bolt which is fixed to or movable by the locking plate and which passes through the locker loop.

7. A locker as claimed in claim 5 including a housing defining a slot and pathway for coin inserted into the assembly, and a latch arranged to inhibit movement of the locking plate until the latch has been displaced by a coin inserted into the assembly.

8. A locker as claimed in claim 6 further including a stop means for limiting the movement of the latch until the locking plate has been moved to lock the locker.

9. A locker as claimed in claim 7 further including a tab mounted on the locking plate and arranged to cooperate with the latch to temporarily retain the coin, until the lock is unlocked.

10. A locker as claimed in claim 6 wherein the locker loop comprises a metal plate defining an aperture capable of receiving a shackle of a padlock.
